(19) United States
(12) Patent Application Publication
(10) Pub. No.: US 2026/0365351 A1
(43) Pub. Date: Nov. 19, 2026

(54) HANDLING APPARATUS FOR PHARMACEUTICAL PRODUCTION MATERIAL, HANDLING SYSTEM WITH A HANDLING APPARATUS, AND PLANT FOR PROCESSING PHARMACEUTICAL CONTAINERS

(71) Applicant: Bausch + Stroebel SE + Co. KG, Ilshofen (DE)

(72) Inventors: Klaus Kaiser, Ilshofen (DE); Martina Graeter, Ilshofen (DE); Daniel Spieler, Ilshofen (DE)

(21) Appl. No.: 19/723,192

(22) Filed: Jun. 29, 2026

Related U.S. Application Data
(63) Continuation of application No. PCT/EP2024/088287, filed on Dec. 22, 2024.

(30) Foreign Application Priority Data
Dec. 29, 2023 (DE) 10 2023 136 884.2

(51) Int. Cl. B65B 7/28; B65B 3/00

(52) U.S. Cl. CPC B65B 7/2821; B65B 3/003

(57) ABSTRACT

A handling apparatus for pharmaceutical production material includes a supporting device, a joint device having first and second jointed arm portions, a drive device, and a tool for acting directly or indirectly on the production material. The handling apparatus also includes a drive element that can be driven about a first axis of rotation and rotationally fixed to the first jointed arm portion. The first and second jointed arm portions are rotatably connected to each other about a second axis of rotation. The handling apparatus further includes a guide device with a guide body and a holding body having or forming the tool or on which the tool is held. A guide element is arranged on the holding body and interacts with the guide body. The handling apparatus can be part of a handling system and used in a plant for processing pharmaceutical containers.

### CROSS-REFERENCE TO RELATED APPLICATIONS

This application is a continuation patent application of international application number PCT/EP2024/088287, filed on Dec. 22, 2024, and claims priority to German application number 10 2023 136 884.2, filed on Dec. 29, 2023. The contents of international application number PCT/EP2024/088287 and German application number 10 2023 136 884.2 are incorporated herein by reference in their entireties and for all purposes.

### FIELD

The present disclosure relates to a handling apparatus for pharmaceutical production material, comprising a tool for acting directly or indirectly on the production material.

The present disclosure further relates to a handling system for pharmaceutical production material, comprising a frame that can be placed on a set-down surface and that comprises a separating element that separates a first zone from a second zone, and a handling apparatus of the type described above.

The present disclosure moreover relates to a plant for processing pharmaceutical containers.

### BACKGROUND

In such a plant, incoming containers are, for example, weighed, filled with a product, weighed again, sealed, and then discharged for further processing. Accordingly, the plant can have a plurality of processing stations-for example, at least one weighing station, one filling station, one sealing station, one inspection station, and/or one packaging station. The containers can comprise, for example, vials, syringes, cartridges, or ampules. They can be stable containers that can stand independently on a set-down element. Non-stable objects are also conceivable, which are held, for example, by means of forcipate gripping elements.

In the present case, containers as primary packaging materials are considered pharmaceutical production material which is not limited to such containers, however. In the present case, for example, secondary packaging materials, in particular trays or tubs accommodating a plurality of containers, can also be considered pharmaceutical production material. Other production materials include, for example, closing elements for closing the containers. Such closing elements can include, for example, plugs, mushroom caps or crimp caps. It is also conceivable for production material to include items used to process the containers in the plant. Examples include filling needles, hoses, container retaining elements, or other production material. In general, for example, format parts of the plant that have container-specific or container-processing-specific properties can be counted as production material.

The handling apparatus of the type mentioned above is used for handling pharmaceutical production material, in particular within such a plant for processing the containers. In this process, the production material can be handled with the tool, which can have different designs, in particular depending upon the production material. The tool can be used to directly or indirectly act on the production material.

Machine handling apparatuses for production material are already known. For example, WO 2022/136537 A1 describes a handling apparatus in the form of a jointed arm robot (Scara) in a plant for processing containers. This handling apparatus has proven itself in practice for the tasks assigned to it. Nevertheless, it would be desirable to provide a handling apparatus that includes advantageous properties for processing the production material.

An object underlying the present disclosure is to provide a handling apparatus that has advantageous properties for processing the production material. The object is furthermore to provide a handling system with such a handling apparatus and a plant for processing containers with such a handling system.

### SUMMARY

In a first aspect of the present disclosure, a handling apparatus in accordance with the present disclosure for pharmaceutical production material is provided. The apparatus comprises a supporting device, a joint device comprising a first jointed arm portion and a second jointed arm portion, at least one drive device, and a tool for acting directly or indirectly on the production material. The handling apparatus comprises a drive element that can be driven about a first axis of rotation and that is connected in a rotationally fixed manner to the first jointed arm portion. The first jointed arm portion and the second jointed arm portion are rotatably connected to each other about a second axis of rotation. The axes of rotation are arranged at a distance from each other. The handling apparatus comprises a guide device with a guide body and a holding body that comprises or forms the tool or on which the tool is held. The second jointed arm portion is rotatable about a third axis of rotation that is arranged at a distance from the second axis of rotation relative to the holding body. At least one guide element is arranged on the holding body and interacts with the guide body.

In a second aspect of the disclosure a handling system for pharmaceutical production material is provided. The system comprises a frame that can be placed on a set-down surface. The frame comprises a, for example, plate-shaped separating element that separates a first zone from a second zone. The first zone has a higher cleanliness class than the second zone; The system further comprises a handling apparatus in accordance with the first aspect, wherein the supporting device and the joint device are arranged in the first zone, wherein the at least one drive device is arranged in the second zone, and wherein at least one coupling element of the handling apparatus is passed through a through-opening of the separating element.

In a third aspect of the disclosure a plant for processing pharmaceutical containers is provided. The plant comprises a handling system in accordance with the second aspect. The handling system comprises or forms a closing station for the containers and at least one further processing station for the containers, for example a filling station.

### BRIEF DESCRIPTION OF THE DRAWINGS

The foregoing summary and the following description may be better understood in conjunction with the drawing figures, of which:

FIG. 1: shows a plant in accordance with the present disclosure for processing pharmaceutical containers in a preferred embodiment, comprising a handling system in accordance with the present disclosure with a handling apparatus in accordance with the present disclosure, each in a preferred embodiment;

FIG. 2: shows a schematic representation of the handling system of the plant from FIG. 1;

FIG. 3: shows a perspective partial representation of the handling apparatus and of a feed apparatus of the handling system from FIG. 1;

FIG. 4: shows an enlarged perspective representation of the handling apparatus in accordance with detail A in FIG. 3;

FIG. 5: shows a partial view of the detail of FIG. 4 in another perspective;

FIG. 6: shows a side view of the feed apparatus, wherein its tool is in a receiving position for closing elements;

FIG. 7: shows the feed apparatus from FIG. 6, wherein the tool is in a transfer position and a push element of the handling apparatus assumes a basic position; and

FIG. 8: shows a representation corresponding to FIG. 7, wherein the push element assumes a pressing position.

### DETAILED DESCRIPTION

Although the present disclosure is illustrated and described herein with reference to specific embodiments, the present disclosure is not intended to be limited to the details shown. Rather, various modifications may be made in the details within the scope and range of equivalents and without departing from the present disclosure.

The present disclosure relates to a handling apparatus for pharmaceutical production material. The apparatus comprises a supporting device, a joint device comprising a first jointed arm portion and a second jointed arm portion, at least one drive device, and a tool for acting directly or indirectly on the production material. The handling apparatus comprises a drive element that can be driven about a first axis of rotation and that is connected in a rotationally fixed manner to the first jointed arm portion. The first jointed arm portion and the second jointed arm portion are rotatably connected to each other about a second axis of rotation. The axes of rotation are arranged at a distance from each other. The handling apparatus comprises a guide device with a guide body and a holding body that comprises or forms the tool or on which the tool is held. The second jointed arm portion is rotatable about a third axis of rotation that is arranged at a distance from the second axis of rotation relative to the holding body. At least one guide element is arranged on the holding body and interacts with the guide body.

In the present disclosure, the holding body can be driven by means of the rotatably driven drive element and moved along the guide body of the guide device. The drive element is rotatably connected to the first jointed arm portion, which is rotatably connected to the second jointed arm portion, which in turn is rotatably connected to the holding body. The tool for handling the pharmaceutical production material is held on the holding body. Alternatively, the holding body can comprise or form the tool. The design of the handling apparatus makes it possible, in particular, to achieve, for example, a linear movement of the tool through a rotational movement of the drive element. Rotary seals for the moving parts ensure a high hygienic standard for the handling apparatus. In particular, translational movements of the drive element and the joint device can be avoided. This prevents particle displacement resulting from translational movements. The handling apparatus is therefore advantageously suitable for use in the plant for processing pharmaceutical containers within a zone with a high cleanliness class, wherein a drive motor of the drive device can advantageously be arranged in a zone with a lower cleanliness class and a drive force of the drive motor can be transmitted to the drive element through a zone boundary. This is discussed below. The use of the joint device, which forms a jointed arm, allows a rotary movement of the drive element to be converted into the in particular linear movement of the tool, wherein the jointed arm portions act as an eccentric device due to the respective distance of the axes of rotation from each other.

Advantageously, the supporting device and the joint device can be given a compact design if the driving force is transmitted by a drive motor arranged externally to the supporting device, as explained above.

It is conceivable, in particular, that a control apparatus be provided for controlling the operation of the handling apparatus.

It can be advantageous if the handling apparatus on the joint device and/or on the supporting device is devoid of a drive motor for a jointed arm portion. In particular, a drive motor of the drive device is not positioned on the supporting device and/or the joint device, but is, for example, located in a zone that is separated by a separating element of the handling system from another zone in which the supporting device and/or the joint device is positioned, wherein the latter zone has a higher degree of cleanliness than the former zone. By eliminating the drive motor at the joint device and/or the supporting device, space and weight can be saved in practice. This allows for a more compact design and lower inertia for shorter cycle times with the handling apparatus.

It can be advantageous if the handling apparatus on the joint device and/or on the supporting device is devoid of a connecting line for a drive motor on the joint device and on the supporting device. It is advantageous, in particular, if no such connecting line (e.g., electrical and/or pneumatic) is passed through the supporting device and the joint device. Eliminating the need for connecting lines simplifies the design configuration of the handling apparatus. Furthermore, there are no connecting lines that are subject to loads resulting from the rotary movement of the drive element and the jointed arm portions, with such loads occurring in particular at joint connections. By eliminating the number of connecting lines, the reliability of the handling apparatus can be increased.

Because a lower weight and a more compact installation space can be achieved compared to a conventional handling apparatus, the use of a pharmaceutically compliant material in the handling apparatus in accordance with the present disclosure presents no difficulties whatsoever.

In particular, stainless steel grade 316L can be used as a material that meets the requirements for cleanability of the handling apparatus.

Alternatively or additionally, a pharmaceutically compliant plastics material can be used, which keeps the weight low and can prove even more advantageous for short cycle times.

The guide body can, for example, be designed to extend in a straight line. For example, the tool can move downwards and upwards along the guide body. This makes it possible, for example, to use the handling apparatus as a closing device for pressing closing elements onto containers or pressing closing elements into containers. In the present case, however, the present disclosure is not limited to this.

However, it can be in particular advantageous if the tool can move in a straight line.

Position and orientation information provided here refers to the intended use of the handling apparatus in the plant.

The guide body can be designed, for example, as a bar or strip.

The guide body can, for example, have a planar guide surface for the at least one guide element. This enables in particular advantageous guide characteristics.

The guide body and the at least one guide element can optionally engage with each other. For example, the at least one guide element engages in at least one groove on the guide body, or vice versa.

The guide body and the at least one guide element are preferably made of a pharmaceutical-grade and abrasion-resistant material. For example, stainless steel is used.

The at least one guide element is, for example, a roller. The roller can, for example, roll off the planar guide surface. Alternatively, the roller can, for example, advantageously comprise a bead along an outer circumference that can engage in a corresponding groove of the guide body.

Two or more guide elements can be provided, arranged on sides of the guide body facing away from one another, so that the guide body is positioned between the guide elements. This allows the holding element to be guided in particular reliably.

It is conceivable that two guide elements are attached to the guide body on one side, with a further guide element attached to the guide body on the opposite side, which is arranged between the first-mentioned guide elements with respect to the direction of movement. This ensures that the holding body does not tilt relative to the guide body and can be reliably guided.

It can be advantageous if the guide body and the holding body with the at least one guide element arranged thereon are devoid of being enclosed by a housing. This allows the guide body, the holding body and the guide elements to be cleaned directly, for example by rinsing or spraying. Furthermore, the handling apparatus can be exposed to a VHP cycle in which the aforementioned components are exposed to a decontamination atmosphere (for example, H₂O₂). Preferably, this allows the handling apparatus to comply with Good Manufacturing Practice (GMP) requirements, Annex 1.

The jointed arm portions can be of different lengths. It is conceivable, for example, that the first jointed arm portion is shorter than the second jointed arm portion. For example, the distance between the first two axes of rotation is smaller than the distance between the second or third axes of rotation.

Alternatively, it can be provided for the jointed arm portions to be of the same length, or for the first jointed arm portion to be shorter than the second jointed arm portion.

The supporting device can, for example, comprise or form a supporting device housing in which the drive element is partially arranged, wherein the drive element is passed through at least one through-opening of the supporting device housing. In this case, the drive element is preferably rotationally sealed relative to the supporting device housing. The sealing device is or includes a rotary sealing element, for example a double wiper.

Advantageously, the drive element is devoid of translational movement relative to the supporting device housing.

The supporting device housing can, for example, comprise a first housing part and a second housing part. For example, the first housing part is configured plate-shaped, and the second housing part is configured hood-shaped. It is conceivable for the supporting device housing to comprise walls that are positioned between the two housing parts. For example, opposite end walls are provided. For example, the at least one through-opening is formed in one of the end walls. The drive element can, for example, be rotatably mounted about the first axis of rotation on at least one end wall via a bearing device.

Bearing devices of the handling apparatus in accordance with the present disclosure and preferred embodiments thereof are, for example, rolling bearings or sliding bearings, wherein the person skilled in the art will select the appropriate bearing depending on the requirements. For rotatable components, a radial bearing is provided in particular. Alternatively or additionally, an axial bearing is conceivable. The bearing device can be single-segmented or multi-segmented. A multi-segmented bearing device comprises, for example, two or more bearing elements arranged at a distance from one another-for example, bearing rings.

As mentioned, the supporting device is advantageously devoid of a drive motor. To transmit a driving force to the drive element, a coupling element can be provided, for example. The handling apparatus can comprise such a coupling element associated with the drive element, which coupling element can be driven by the at least one drive device, wherein the coupling element engages in the supporting device housing and is coupled therein to the drive element. Due to the coupling element, a drive motor can be arranged in particular outside the supporting device housing. The coupling element, for example, transmits a driving force from the drive motor arranged in a substructure of the handling system within a zone that is separated from the zone in which the supporting device is arranged by a separating element. For example, the latter zone has a higher cleanliness class than the former zone. This arrangement of the drive motor allows, for example, the drive motor to be designed to be larger and therefore more robust, which is not possible when positioning the drive motor in the supporting device due to space and weight constraints. This increases the reliability of the handling apparatus.

The coupling element can preferably be driven in rotation, wherein, in particular, a bearing device is provided for the rotary movement.

The coupling element can be coupled to the drive element, for example, via a gear connection. For example, meshing bevel gears prove advantageous for a compact design.

As already mentioned, the production material could, for example, be closing elements for containers. For handling the closing elements, the tool can, for example, include at least one push element for acting on a closing element, which is intended in particular for closing a pharmaceutical container. The push element is, for example, a plunger, via which a closing element is pressed out of a receptacle onto or into the container.

The tool can be designed with multiple positions to allow simultaneous processing of several closing elements and containers. Accordingly, the tool can include a plurality of push elements. The push elements are preferably configured identically.

It can prove advantageous if, in a preferred embodiment of the present disclosure, components of the handling apparatus are present multiple times, in particular twice. Multiple components can advantageously be configured to be identical or functionally equivalent, for example, symmetrical relative to each other.

For example, the guide device comprises two guide bodies.

For example, two support structures are provided.

For example, two joint devices with two jointed arm portions are provided.

For example, two holding bodies and guide elements arranged on each of them are provided.

For example, two drive elements are provided.

Ideally, the tool is held by the two holding bodies, or both holding bodies comprise or form the tool.

The handling apparatus can comprise two coupling elements, each coupled to a respective drive element.

The guide devices, the supporting devices, the joint devices, the holding bodies and the drive elements are each positioned at a distance from one another. This allows the tool to be driven from two opposite sides, for example, and it is arranged in particular between the two holding bodies.

It can be advantageous if the at least one drive device comprises a drive motor for driving the two drive elements, in particular indirectly via two coupling elements. For example, the drive device includes one that is rotationally fixed to both coupling elements. This makes it possible to easily achieve mechanical synchronization between the coupling elements and thus the drive elements. In practice, this allows for a structurally simple design of the handling apparatus while simultaneously ensuring reliably guided movement of the tool.

Alternatively, the drive device may comprise two separate drive motors, each assigned to a respective coupling element, with the drive motors preferably being synchronized with each other. This allows, for example, electronic synchronization of the drive motors. The use of two drive motors increases the versatility of the handling apparatus in accordance with the present disclosure.

The object mentioned at the outset is further achieved by a handling system in accordance with the present disclosure for pharmaceutical production material, comprising a frame that can be placed on a set-down surface and that comprises an in particular plate-shaped separating element that separates a first zone from a second zone, wherein the first zone has a higher cleanliness class than the second zone, a handling apparatus of the type described above, wherein the supporting device and the joint device are arranged in the first zone, wherein the at least one drive device is arranged in the second zone, wherein at least one coupling element of the handling apparatus is passed through a through-opening of the separating element.

The advantages already mentioned in connection with the handling apparatus in accordance with the present disclosure can also be achieved with the handling system. Reference is made to what has been stated above.

Advantageous embodiments of the handling system in accordance with the present disclosure result from advantageous embodiments of the handling apparatus in accordance with the present disclosure. In this regard too, reference is made to the above statements.

With the handling system in accordance with the present disclosure, it is advantageous that the drive device, in particular a drive motor, is arranged in the second zone. The driving force is transmitted via the coupling element through the separating element into the region of the first zone in order to drive the corresponding drive element there. As explained above, the supporting device and/or the joint device is advantageously devoid of a drive motor and/or connecting lines therefor.

The first zone can be a cleanroom—for example, of class A, B, C, or D. The separating element can be covered by machine guard with appropriate walls and/or by an isolator device.

The separating element can, for example, be a tabletop of the frame.

The handling system can, for example, comprise an in particular column-shaped carrying device in which the at least one coupling element is arranged and which extends through or engages in the through-opening or rests against the edge of the through-opening in the first zone. The carrying device forms, for example, a housing or enclosure for the at least one coupling element.

Preferably, the handling system comprises a sealing device for sealing the through-opening between the first zone and the second zone.

The at least one coupling element or the carrying device is devoid of a linear movement, in particular a lifting movement, through the through-opening. This prevents a transfer of germs from the second zone to the first zone and thus increases the hygienic standard of the handling system.

The handling apparatus and handling system preferably only use rotary movements and corresponding rotary seals. Translational movements, such as lifting movements, are preferably not present during operation in any case in order to avoid corresponding particle carryover as a result of the translational movements.

It may be provided that translational movements are possible, for example, only for setup work before actual operation, but not during operation.

In a preferred embodiment of the present disclosure, the handling system advantageously comprises at least one transport path for closing elements and a holding element for containers to be closed. Depending upon the type of container, the holding element can, for example, be a set-down element for stable containers or a gripping element for non-stable containers.

In the last-mentioned advantageous embodiment, the tool is in particular movable in a straight line from a basic position to a pressing position and vice versa, wherein the push elements in the basic position have a greater distance from the closing elements than in the pressing position, and wherein the closing elements in the pressing position can be subjected to a force pointing towards the containers. The force can be used, for example, to push the closing elements out of a receptacle onto or into the containers.

A plant in accordance with the present disclosure for processing pharmaceutical containers comprises a handling system of the type described above, wherein the handling system comprises or forms a closing station for the containers, and wherein at least one further processing station for the containers is provided, for example, a filling station. For example, closing elements are fed to the containers filled with a product, and the closing elements are placed on or in the containers by means of push elements.

The plant in accordance with the present disclosure then exhibits the advantages and effects mentioned in connection with the handling apparatus and the handling system. Advantageous embodiments of the plant result from advantageous embodiments of the handling apparatus and handling system.

FIG. 1 shows, in a schematic representation, an advantageous embodiment of the plant in accordance with the present disclosure for processing pharmaceutical containers, which is denoted as a whole by reference numeral 100. In the present case, the containers 102 are for example vials 104 which are shown in FIGS. 7 and 8. However, the present disclosure is not limited to this type of container 102.

The plant 100 allows the containers 102 to be processed at a plurality of processing stations 106. The processing stations 106 comprise, for example, at least one weighing station 108 for tare weighing and gross weighing of the containers in an empty or filled state, a filling station 110 for filling the containers 102 with a product, and a closing station 112. At the closing station 112, the containers can be closed using closing elements 114.

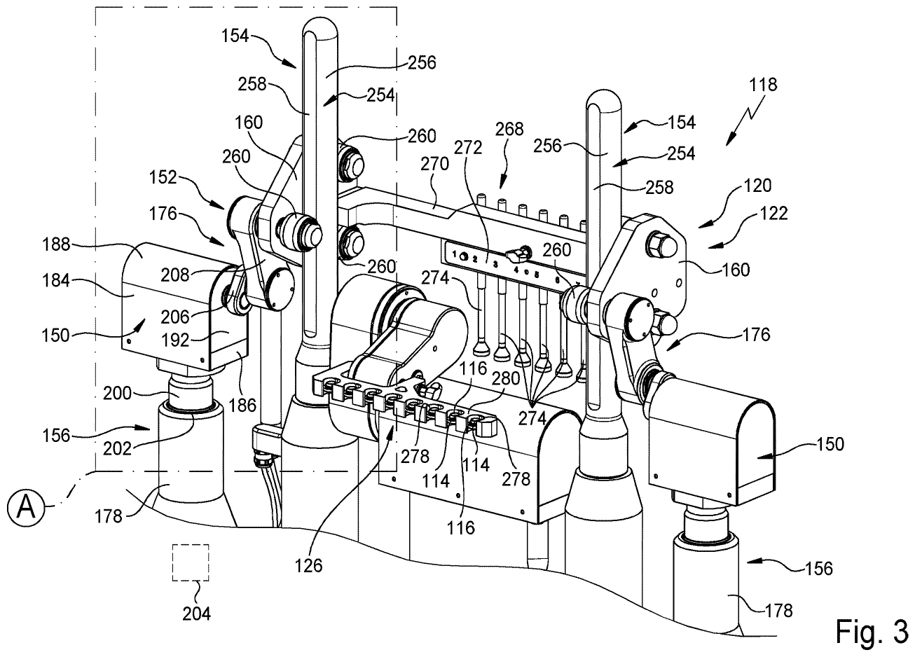

The closing elements 114 are shown in FIGS. 3 and 6 to 8. The closing elements 114 are part of pharmaceutical production material 116. From what has been said, it shall be understood that the present disclosure is not limited to closing elements 114 as production material 116.

The plant 100 comprises the handling system 118 in accordance with the present disclosure in a preferred embodiment, which in turn comprises the handling apparatus 120 in accordance with the present disclosure in a preferred embodiment. The handling apparatus 120 is configured in this case as a closing device 122 for pressing the closing elements 114 onto the containers 102. Furthermore, the handling apparatus 120 includes a storage apparatus 124 for storing the closing elements 114 and a feed apparatus 126 with which the closing elements 114 can be fed to the locking device 122.

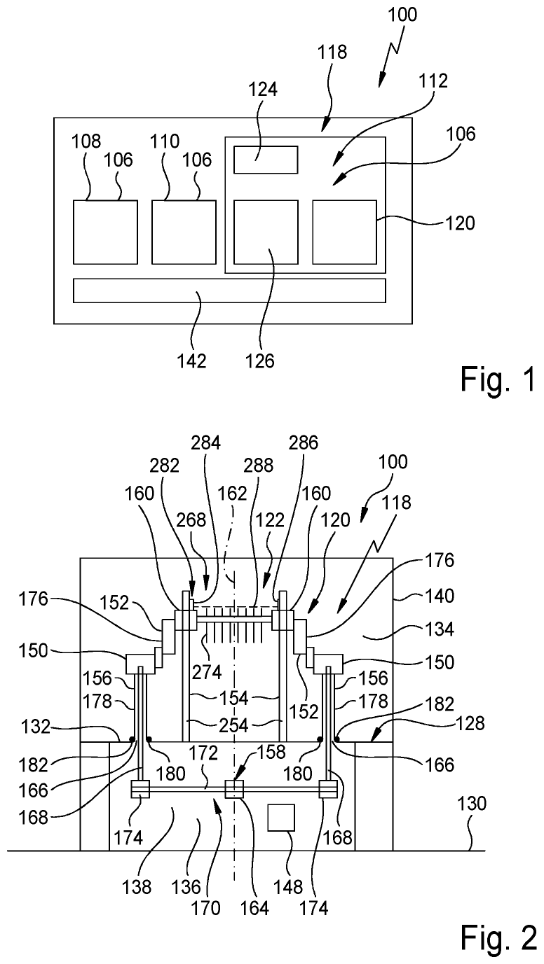

As can be seen, for example, in FIG. 2, the handling system 118 comprises a frame 128 which can be positioned on a set-down surface 130 of a room—for example, a laboratory. The frame 128 comprises a separating element 132, which in the present case is configured plate-shaped and can in particular form a set-down element for processing stations 106. The separating element 132 can in particular be a tabletop of the frame 128.

The separating element 132 separates a first zone 134 from a second zone 136. The cleanliness class of the first zone 134 is higher than the cleanliness class of the second zone 136. In particular, the first zone 134 is part of a cleanroom—for example, of cleanliness class A, B, C, or D. The second zone 136 is located below the separating element 132 and is thus in the substructure 138 of the handling system 118, which at the same time is also a substructure 138 of the plant 100.

The first zone 134 is preferably covered by a machine guard or an isolator device 140, with which the cleanliness class can be ensured.

Within the first zone 134, the containers 102 can be transported along the processing stations 106 by means of a transport system 142. In the present case, the vials 104 are stable containers 102, so that the transport system 142 comprises a set-down element 144 (FIGS. 7 and 8). The set-down element 144 is formed, for example, by a conveyor belt, although the present disclosure is not limited to this.

In the present exemplary embodiment of the handling system 118, the containers can be positioned on the set-down element 144 regardless of their size such that the container axes 146 are fixed in space. For processing on the handling system 118, the containers 102 also have defined positions along the transport system 142.

A control apparatus 148 is provided for controlling the operation of the plant 100. The control apparatus 148 can at the same time be a control apparatus of the handling system 118 and of the handling apparatus 120. Advantageously, it is operatively connected to all controllable components of the plant 100.

As can be seen in particular in FIG. 2 to 5, the handling apparatus 120 comprises a supporting device 150, a joint device 152, a guide device 154, a carrying device 156, a drive device 158 and a holding body 160.

As can be seen, for example, from FIGS. 2 and 3, the handling system 118 comprises two supporting devices 150, two joint devices 152, two guide devices 154, two carrying devices 156 and two holding bodies 160. The components, each present in duplicate, are configured to be mirror-symmetrical relative to each other with respect to a central plane 162 of the handling system 118. The components mentioned are functionally identical. Therefore, only one of the functionally identical components will be discussed in the following. The statements made in this regard also apply to the other components.

The drive device 158 is present only once. It includes a drive motor 164. The drive motor 164 is, for example, a servomotor or a stepper motor and is arranged in the second zone 136 and thus in the substructure 138.

The drive motor 164 is, for example, held on the underside of the separating element 132 or otherwise on the frame 128.

In the present case, two through-openings 166 are formed in the separating element 132 (FIG. 2). A coupling element 168 is passed through the respective through-opening. The coupling elements 168 are also symmetrical to each other with respect to the central plane 162. The drive motor 164 can be used to drive the joint device 152 to move the holding body 160 along the guide device 154. For this purpose, the handling system 118 comprises a transmission device 170, which in this case is configured as a belt drive with a drive belt 172. The drive belt 172 is driven by the drive motor 164 and is in rotationally fixed engagement with a drive member 174 on the coupling element 168. The drive belt 172, for example, is a timing belt.

In the present case, both coupling elements 168 can be driven synchronously in order to reliably guide both holding bodies 160 along the guide devices 154. This allows for a structurally simple design of the handling system 118, as separate drive motors 164 for the coupling elements 168 can be omitted.

In contrast, no drive motors are arranged on or in the supporting device 150 and on or in the joint device 152. Also, no connecting lines, e.g., electrical lines and/or pneumatic lines, are arranged in the supporting device 150 and in the joint device 152 and in particular are also not passed through said devices 150, 152.

Overall, this results in a compact design for the handling apparatus 120 with a relatively low mass compared to conventional handling apparatuses. Due to its compact design and low mass, this makes it possible to increase the work cycle achievable with the handling apparatus. At the same time, it is possible to use the handling apparatus 120 in regions of the plant 100 where there is little installation space available.

In the present exemplary embodiment, the supporting device 150 virtually forms a base for the joint device 152, which in turn forms a joint arm 176. In the present example, the supporting device 150 is mounted on top of the carrying device 156 which is configured column-shaped (FIGS. 2 and 3).

In a different embodiment, the supporting device 150 could, for example, be arranged directly on the separating element 132.

The carrying device 156 forms an enclosure 178 for the coupling elements 168 and encloses them in a circumferential direction.

In the present case, the carrying device 156 is located at an edge 180 of the through-opening 166. Alternatively, it could be provided, for example, for the carrying device 156 to engage in or extend through the through-opening 166.

It can be advantageous if a sealing device 182 is present between the first zone 134 and the second zone 136. For example, the sealing device 182 seals between the carrying device 156 and the edge 180 of the through-opening 166. The sealing device 182 is shown schematically in FIG. 2.

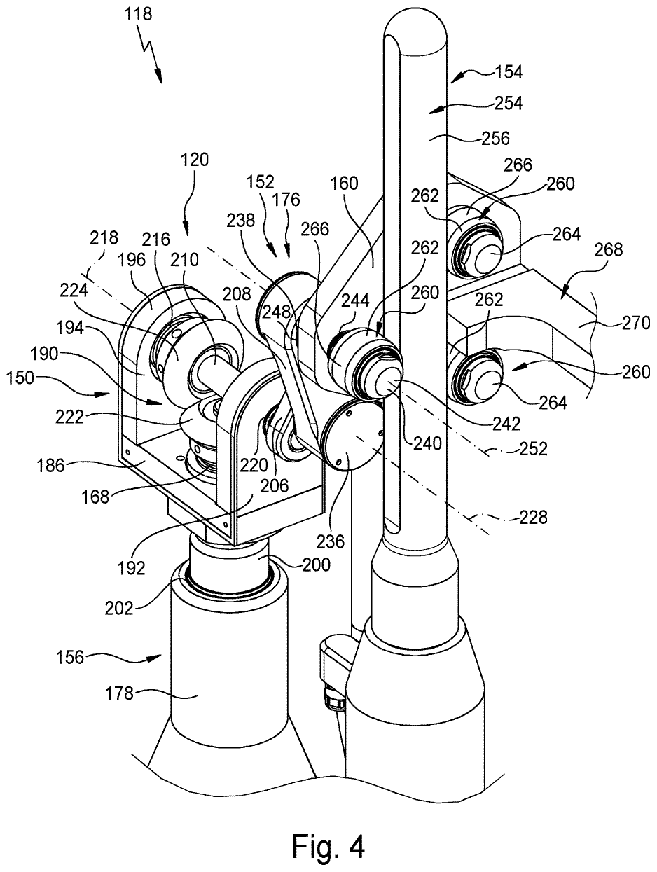

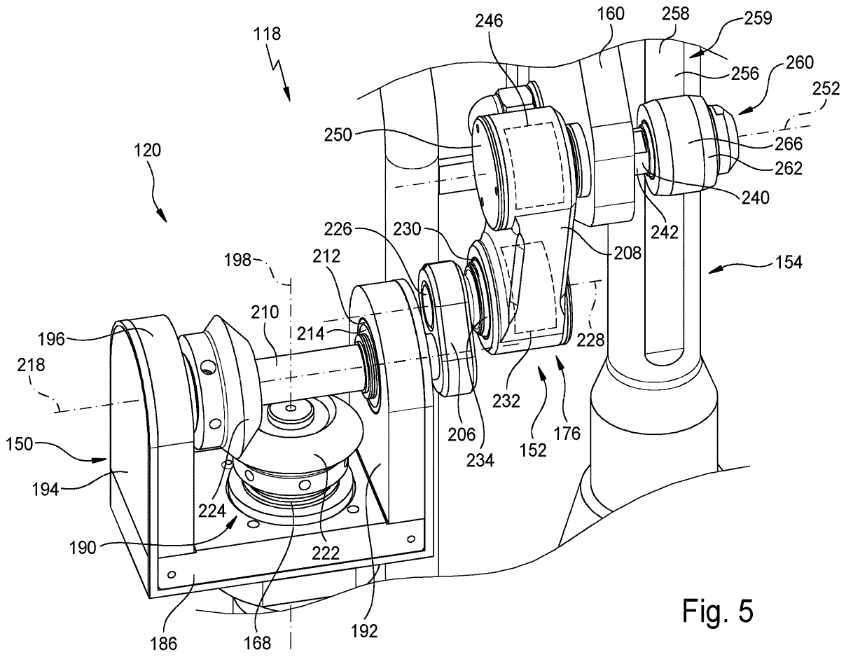

As can be seen in particular in FIG. 3 to 5, the supporting device 150 in the present exemplary embodiment comprises a supporting device housing 184 (hereinafter: housing 184), which is shown open in FIGS. 4 and 5. The housing 184 is fixed to the carrying device 156 at the top.

The housing 184 comprises a housing part 186, which is plate-shaped in the present example and forms a bottom of the housing 184, and a further housing part 188, which is hood-shaped in the present example. The housing part 188 overlaps the housing part 186 (FIG. 3) and together they enclose a receiving chamber 190 (shown open in FIGS. 4 and 5).

Furthermore, the housing 184 includes end walls 192, 194 at opposite ends.

A sealing device 196 seals the housing 184, in this case between the end walls 192, 194 and the housing part 188. The housing 184 is therefore sealed in particular in a pharmaceutically compliant manner, so that it is possible to spray-wash or rinse the housing 184 for cleaning. The housing 184 can be subjected to a VHP cycle, in particular with H₂O₂.

The coupling element 168 engages through the housing part 186 into the receiving chamber 190. In the present case, the coupling element 168 is rotatable about a pivot axis 198. A rotatable bearing exists at the carrying device 154.

It can be in particular advantageous if there is no translational movement of the coupling element 168. The driving force of the drive motor 164 to the holding body 160 is transmitted solely via rotary movements. By avoiding translational movements, in particular between the first zone 134 and the second zone 136, the risk of particles being introduced is reduced, so that the hygienic standard of the handling apparatus 120 is high.

Such a configuration of the carrying device 156 and the coupling element 168 is shown schematically in FIG. 2.

In a different embodiment, it may be possible within the scope of the present disclosure that a translational movement of the coupling element 168 is conceivable. For this purpose, a support body 200 can be displaceable relative to the carrying device 156, within which body the coupling element 168 can be rotated about the axis of rotation 198 (FIG. 3 to 5). A sealing device 202 acts between the support body 200 and the carrying device 156 to seal the axial movement of the support body 200.

However, it may be intended in particular that such a translational movement is not carried out during the operation of plant 100, but only during preparatory measures, for example during maintenance and/or setup work. This is conceivable, for example, in the case of a format change.

During the operation of the plant 100, the support body 200 is preferably immobile relative to the carrying device 156 in order to avoid the carryover of particles, in particular dirt particles, into the first zone 134. Only the rotating coupling element 168 is used to drive the movement of the holding body 160 during operation. The rotational movement is sealed via the sealing device 202. This significantly improves the hygienic properties.

FIG. 3 schematically shows a drive unit 204 for the support body 200. The drive unit 204 can, for example, be or include a spindle drive. Preferably, both support bodies 200 on the two sides of the handling system 118 can be driven together by means of only one drive unit 204.

The jointed arm 176 comprises a first jointed arm portion 206, which is rotatable relative to the supporting device 150, and a second jointed arm portion 208, which is rotatable relative to the first jointed arm portion 206. The second jointed arm portion 208 is rotatable relative to the holding body 160.

In this case, the first jointed arm portion 206 is shorter than the second jointed arm portion 208. The length ratio is approximately 1:2 to 1:3.

For rotating the jointed arm portion 206, the handling apparatus 120 comprises a drive element 210 on the respective supporting device 150. In the present case, the respective drive element 210 is designed as a shaft which is partially arranged in the receiving space 190 and is passed through a through-opening 212 of the housing 184. For this purpose, the through-opening 212 is formed in the end wall 192.

It is understood that the drive elements 210 are designed symmetrically relative to one another and are functionally identical.

Bearing devices 214, 216 allow the drive element 210 to be rotatably mounted about a (first) axis of rotation 218. The bearing devices 214, 216 are arranged on the end walls 192, 194.

The drive element 210 is sealed relative to the end wall 192 of the housing 184 via a sealing device 220. The sealing device 220 serves for rotary sealing with a rotary sealing element, for example a double wiper.

In the present case, the drive element 210 is coupled to the coupling element 168 via meshing bevel gears 222 at the coupling element 168 and via meshing bevel gears 224 at the drive element 210. By rotating the coupling element 168, the drive element rotates about the axis of rotation 218, which is aligned perpendicular to the axis of rotation 198.

The drive element 210 is connected in a rotationally fixed manner to the first jointed arm portion 206 forming a cam.

Furthermore, a power transmission element 226, arranged at a distance from the drive element 210, is coupled in a rotationally fixed manner to the first jointed arm portion 206. This defines a (second) axis of rotation 228, which is arranged at a distance from the first axis of rotation 218 and aligned parallel to it.

The power transmission element 226 is rotatably mounted on the second jointed arm portion 208. For this purpose, a bearing device is arranged in a receiving opening 230 of the jointed arm portion 208. A sealing device 234 seals between the power transmission element 226 and the jointed arm portion 208, in this case in the form of a rotary seal with a rotary sealing element, for example a double wiper.

The receiving opening 230 is in this case a through-opening which is closed on the side facing away from the jointed arm portion 206 by means of a cover element 236.

In the present example, the second jointed arm portion 208 includes a further receiving opening 238, configured as a through-opening. A power transmission element 240 engages in the receiving opening 238, which in this case is configured as a shaft 242. The shaft 242 is guided through a through-opening 244 of the holding body 160 in a rotationally fixed manner.

In the jointed arm portion 208, the shaft 242 is rotatably mounted via a bearing device 246. A sealing device 248 seals the rotary movement and is configured as a rotary sealing element, for example a double wiper. (FIG. 3). On the side facing away from the holding body 160, the receiving opening 238 is closed by means of a cover element 250.

The (third) axis of rotation 252 defined by the shaft 242 is arranged at a distance from the axes of rotation 218 and 228 and aligned parallel to them.

In the present example, the holding body 160 is configured in a plate-like shape. One plane of the holding body 160 is oriented transversely and, in particular, perpendicularly to the axes of rotation 218, 228 and 252.

The guide device 154 comprises a guide body 254. In the present case, the guide body 254 is designed in a columnar shape and is aligned transversely and, in particular, perpendicularly to a plane of the separating element 132. For example, the guide body 254 is fixed to the separating element 132.

A strip-shaped guide portion 256 is formed on the guide body 254. The guide portion 256 has at least one planar guide surface 258 extending along the direction of movement of the holding body 160. In the present case, two guide surfaces 258 are arranged on sides of the guide portion 256 facing away from one another.

According to the present disclosure, at least one guide element 260 is arranged to guide the holding body 160 on the guide body 254. The present disclosure includes a plurality of guide elements 260, for example three pieces, and the present disclosure is not limited to these.

The guide elements 260 are configured as rollers 262. A first roller 262 is rotatably mounted on the shaft 242. For this purpose, the roller 262 has a bearing device. Furthermore, a rotary seal relative to the shaft 242 is provided by means of a sealing element.

While the roller 262 held on the shaft 242 is arranged on one side of the guide portion 256, the two other rollers 262 are arranged on the opposite side of the guide portion 256, in the present case facing away from the roller 262. Along the direction of movement of the holding body 160, which is defined by the extension direction of the guide body 254, these two rollers 262 are spaced apart from each other. The first roller on the shaft 242 is arranged along the direction of movement between the two rollers 262 on the opposite side (FIG. 4).

The latter two rollers are rotatably mounted on fixing elements 264, which are held in a rotationally fixed manner on the holding body 160. Furthermore, a sealing device exists in relation to the fixing element 264 by means of a rotary sealing element.

Rolling surfaces 266 are arranged circumferentially on the rollers 262, over which rolling surfaces the rollers 262 roll on the respective guide surface 258, which is formed on the guide portion 256 and faces the respective roller 262. This results in a in particular reliable guidance of the holding body 160.

The holding body 160, the rollers 262 and the guide body 254 are devoid of any enclosure. This allows these components to be cleaned during cleaning of the handling apparatus 120, for example by rinsing or spraying. Furthermore, the components can be subjected to a VHP cycle for decontamination, for example using H₂O₂.

In order to avoid abrasion on the guide body 254 and on the rollers 262 during operation of the handling apparatus, the rollers 262, at least in the region of the rolling surfaces 266, and the guide body 254, at least in the region of the guide portion 256, are made of an abrasion-resistant and preferably pharmaceutical-grade material, in particular stainless steel.

When the coupling element 168 rotates, the drive element 210 is rotated about the axis of rotation 218. The same applies to the cam formed by the first jointed arm portion 206. This in turn rotates relative to the second jointed arm portion 208 around the second axis of rotation 228. The second jointed arm portion 208 rotates relative to the holding body 160 around the third axis of rotation 252.

This results in the holding body 160 being moved, with the movement taking place along the guide body 254. It is a linear movement. In the present example, this is in particular an up and down movement.

Such a movement is performed by both holding bodies 160, with the movements being synchronized with each other via the transmission device.

The handling apparatus 120 comprises a tool 268 for handling the closing elements 114. The tool 268 in this case has a support part 270 which is preferably detachably fixed to both holding bodies 160 and connects the two holding bodies 160 to each other.

Furthermore, the tool 268 has a holding part 272 which is preferably detachably fixed to the support part 270. The holding part 272 holds at least one sliding element 274 for a closing element 114. The push element 274 is configured as a plunger.

In the present case several push elements 274 are present, which are fixed to the holding part 272 in an equidistant position relative to each other. The holding part 272 can be designed together with the push elements 274 as a container-specific format part. Alternatively, for example, only the push elements 274 can be format parts that are detachably fixed to the holding part 272.

The drive motor 164 allows the push elements 274 to be moved translationally through the guided holding bodies 160. In particular, it is possible to lower and raise the push elements 274. The range of motion of the push elements 274 is defined by the design of the joint device 152 and its points of application on the supporting device 150 and on the holding body 160.

If the supporting device 150 can be moved relative to the carrying device 156 via the drive unit 204 over the support bodies 200, the height relative to which the push elements 274 can be lowered and raised can be adjusted.

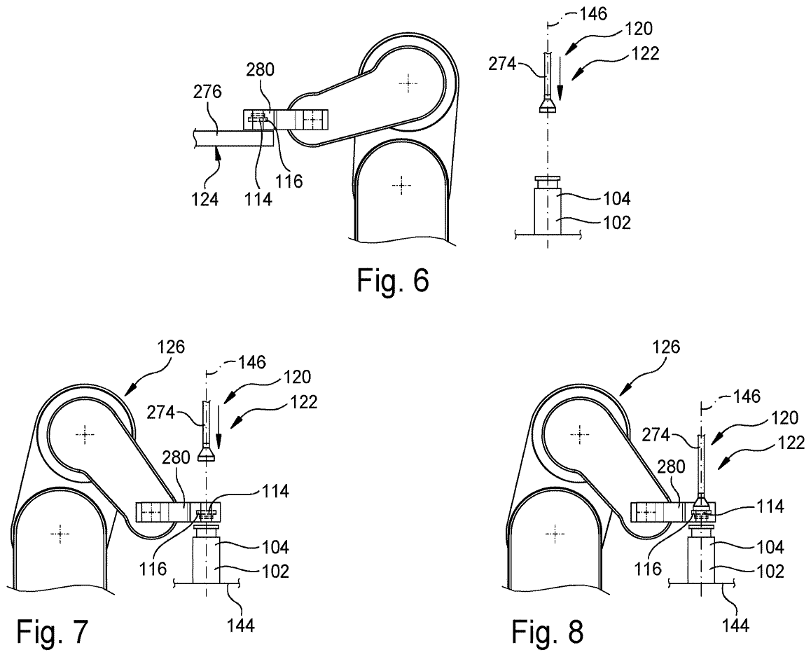

When the handling system 118 is in operation, closing elements 114 are fed back by the storage apparatus 124, which for this purpose may in particular have feed paths 276 (FIG. 6). Upstream of the feed paths 276, the storage apparatus 124 comprises, for example, a container for closing elements 114-for example, in the form of a conveyor pot.

The number of feed tracks 276 preferably corresponds to the number of push elements 274 and the number of receptacles 278 of a receiving body 280 of the feed apparatus 126.

The closing elements 114 are conveyed from the feed tracks 276 into the receptacles 278 (FIG. 6, not shown in detail).

The feed apparatus 126 moves the receiving body 280 from the receiving position shown in FIG. 6 to a transfer position shown in FIGS. 7 and 8.

In the transfer position, the closing elements 114 are positioned above containers 102, which are positioned on the set-down elements 144. The closing elements 114 are aligned relative to the containers 102.

During this transport of the closing elements 114, the push elements 274 assume a basic position (FIG. 7) in which they are arranged above the closing elements 114. Subsequently, the push elements 274 are transferred into a pressing position towards the closing elements 114 (FIG. 8) in order to exert a force on the closing elements 114 towards the containers 102.

The guided movement of the push elements 274 takes place along the container axes 146, which are aligned parallel to the extension of the guide body 254. The closing elements 114 are pressed from the receptacles 278 onto the containers 102 via the push elements 274 in order to close them.

A sensor device 282 can be provided (FIG. 2) which can be coupled to the control device 148 and via which the proper function of the handling apparatus 118 can be monitored. In the event of a malfunction, the handling apparatus 118 can be taken out of service.

The sensor device 282 is, for example, optically configured and comprises in this case a light barrier (e.g., with laser light) with a transmitting and receiving element 284 and a mirror 286. The transmitting and receiving element 284 is, for example, fixed to the frame 128 and the mirror 286 to the holding body 160 or to the support part 270. Reference numeral 288 symbolizes the light path.

Each of the push elements 274 is provided with a mechanical overload protection device, which in this case is arranged in the holding part 272. In case of overload due to the pressing force, the corresponding push element 274 disengages. This can be detected by means of the sensor device 282 by interrupting the light path 288.

### LIST OF REFERENCE NUMERALS

100 plant
102 container
104 vial
106 processing station
108 weighing station
110 filling station
112 closing station
114 closing element
116 production material
118 handling system
120 handling apparatus
122 closing apparatus
124 storage apparatus
126 feed apparatus
128 frame
130 set-down surface
132 separating element
134 first zone
136 second zone
138 substructure
140 machine guard
142 transport system
144 set-down element
146 container axis
148 control apparatus
150 supporting device
152 joint device
154 guide device
156 carrying device
158 drive device
160 holding body
162 central plane
164 drive motor
166 through-opening
168 coupling element
170 transmission device
172 drive belt
174 drive member
176 jointed arm
178 enclosure
180 edge
182 sealing device
184 supporting device housing
186, 188 housing part
190 receiving space
192, 194 end wall
196 sealing device
198 axis of rotation
200 support body
202 sealing device
204 drive unit
206 first jointed arm portion
208 second jointed arm portion
210 drive element
212 through-opening
214, 216 bearing device
218 first axis of rotation
220 sealing device
222, 224 bevel gear
226 power transmission element
228 second axis of rotation
230 receiving opening
232 bearing device
234 sealing device
236 cover element
238 receiving opening
240 power transmission element
242 shaft
244 through-opening
246 bearing device
248 sealing device
250 cover element
252 third axis of rotation
254 guide body
256 guide portion
258 guide surface
260 guide element
262 roller
264 fixing element
266 rolling surface
268 tool
270 support part
272 holding part
274 push element
276 feed path
278 receptacle
280 receiving body
282 sensor device
284 transmitting and receiving element
286 mirror
288 light path

1. A handling apparatus for pharmaceutical production material, the handling apparatus comprising:
a supporting device;
a joint device having a first jointed arm portion and a second jointed arm portion;
at least one drive device;
a tool for acting directly or indirectly on the pharmaceutical production material; and
a guide device with a guide body and a holding body that comprises or forms the tool or on which the tool is held,
the handling apparatus comprising a drive element that is drivable about a first axis of rotation and connected in a rotationally fixed manner to the first jointed arm portion,
the first jointed arm portion and the second jointed arm portion being rotatably connected to each other about a second axis of rotation,
the first axis of rotation and the second axis of rotation being arranged at a distance from each other,
the second jointed arm portion being rotatable about a third axis of rotation arranged at a distance from the second axis of rotation relative to the holding body, and
at least one guide element being arranged on the holding body and cooperating with the guide body.

2. The handling apparatus according to claim 1,
wherein
the handling apparatus on the joint device and/or on the supporting device is devoid of a drive motor for a jointed arm portion, and/or wherein the handling apparatus on the joint device and/or on the supporting device is devoid of a connecting line for a drive motor on the joint device and on the supporting device.

3. The handling apparatus according to claim 1,
wherein
the guide body is designed to extend in a straight line as a bar or strip.

4. The handling apparatus according to claim 1,
wherein
the guide body has a planar guide surface for the at least one guide element.

5. The handling apparatus according to claim 1,
wherein
at least one of the following applies:
the at least one guide element is a roller;
two or more guide elements are provided, wherein two guide elements of the two or more guide elements are arranged on sides of the guide body facing away from one another.

6. The handling apparatus according to claim 5, wherein the roller is made of a metal material.

7. The handling apparatus according to claim 1,
wherein
the guide body and the holding body with the at least one guide element arranged thereon are devoid of being enclosed by a housing.

8. The handling apparatus according to claim 1,
wherein the first jointed arm portion and the second jointed arm portion are of different lengths, and
wherein the first jointed arm portion is shorter than the second jointed arm portion.

9. The handling apparatus according to claim 1,
wherein
the supporting device comprises or forms a supporting device housing in which the drive element is partially arranged, wherein the drive element is passed through at least one through-opening of the supporting device housing, and wherein the drive element is rotationally sealed relative to the supporting device housing.

10. The handling apparatus according to claim 9,
wherein
the handling apparatus comprises a coupling element associated with the drive element, which coupling element is drivable by the at least one drive device, wherein the coupling element engages in the supporting device housing and is coupled to the drive element in the supporting device housing.

11. The handling apparatus according to claim 10,
wherein
the coupling element is coupled to the drive element via a toothed connection.

12. The handling apparatus according to claim 1,
wherein
the tool comprises at least one push element for acting on a closing element for closing a pharmaceutical container.

13. The handling apparatus according to claim 12,
wherein
the tool is designed with multiple positions and comprises a plurality of push elements.

14. The handling apparatus according to claim 1,
wherein
the guide device comprises two guide bodies, wherein two supporting devices are provided, wherein two drive elements are provided, wherein two joint devices each with two jointed arm portions are provided, and wherein two holding bodies and guide elements arranged thereon are provided, wherein the tool is held on both holding bodies or both holding bodies comprise or form the tool.

15. The handling apparatus according to claim 14,
wherein the at least one drive device comprises a drive motor for driving the two drive elements, and
wherein the handling apparatus comprises two coupling elements which are coupled to a respective drive element.

16. The handling apparatus according to claim 15,
wherein
the at least one drive device comprises two separate drive motors which are assigned to a respective coupling element, wherein the two separate drive motors are synchronized with each other.

17. A handling system for pharmaceutical production material, the handling system comprising:
the handling apparatus according to claim 1; and
a frame that is placeable on a set-down surface,
the frame comprising a separating element and a plate-shaped element that separates a first zone from a second zone,
the first zone having a higher purity class than the second zone,
the supporting device and the joint device being arranged in the first zone,
the at least one drive device being arranged in the second zone,
wherein at least one coupling element of the handling apparatus is passed through at least one through-opening of the separating element.

18. The handling system according to claim 17, further comprising a column-shaped carrying device in which at least one coupling element associated with the drive element is arranged, the at least one coupling element being drivable by the at least one drive device, and extending through or engaging in the at least one through-opening or resting against an edge of the at least one through-opening in the first zone, and a sealing device for sealing the at least one through-opening between the first zone and the second zone.

19. The handling system according to claim 18, wherein the at least one coupling element or the column-shaped carrying device is devoid of a linear movement through the at least one through-opening.

20. The handling system according to claim 17, further comprising:
at least one transport path for closing elements; and
a holding element for containers to be closed,
wherein the tool is movable from a basic position to a pressing position, and vice versa,
wherein the tool comprises a plurality of push elements,
wherein the plurality of push elements have a greater distance from the closing elements in the basic position than in the pressing position, and
wherein the closing elements are subjectable to a force in a direction of the containers in the pressing position.

21. A plant for processing pharmaceutical containers, the plant comprising:
the handling system according to claim 17,
wherein the handling system comprises or forms a closing station for the pharmaceutical containers, and
wherein at least one further processing station for the pharmaceutical containers is a filling station.
